(19) United States
(12) Patent Application Publication
(10) Pub. No.: US 2017/0086445 A1
(43) Pub. Date: Mar. 30, 2017

(54) Attachment of Hoof Blocks

(71) Applicant: Moowell Ltd., Stalbridge Dorset (GB)

(72) Inventors: Robert Iain MacFarlane Todd, Stalbridge, Dorset (GB); Michael Harvey Brimble, Stalbridge Dorset (GB)

(21) Appl. No.: 15/126,485

(22) PCT Filed: Mar. 17, 2015
(86) PCT No.: PCT/GB2015/050772

§ 371 Date: Sep. 15, 2016

(30) Foreign Application Priority Data
Mar. 17, 2014 (GB) 1404697.3

(51) Int. Cl. A01L 9/00; A01L 15/00; A01K 13/00

(52) U.S. Cl. CPC A01L 9/00; A01K 13/007; A01L 15/00

(57) ABSTRACT

A device (10) for elevating the injured claw of a cloven hooted animal, particularly but not exclusively a bovine animal, is described. The device comprises means (12) lor receiving the claw of a cloven hoofed animal and means (16) for retaining a hoof block (20).

This invention relates to shoes for cloven hoofed animals. More particularly this invention relates to shoes for cloven hoofed animals with hoof or foot problems.

The description which follows refers to cows but the present invention finds equal utility in any cloven hoofed animal, especially commercially kept animals such as sheep, goats, deer, but also in other hoofstock such as in wild animal parks, zoos or even in wild animals.

A cow's hoof has two claws. Cows hooves grow continually and wear from walking will often keep the hoof from becoming overgrown. However, especially with dairy herds, hoof wear may be uneven or may be insufficient to prevent overgrowth. Additionally, the living environment of the cow, such as a concrete floor in a milking shed, may cause uneven wear of the hooves or even of the claws of the same hoof. Hence, one or both claws of a hoof may suffer problems such as overgrowth, injury or infection and this can lead to lameness or other mobility issues. More seriously, more than one hoof of the animal can be affected.

Good animal husbandry therefore advocates that cows' hooves are checked regularly. Problems such as overgrowth, infection, ulcers and the like are often treated by trimming the hoof to remove the overgrowth or the damaged and/or diseased part of the hoof and the use of footbaths to treat any infection. One common ailment of the hoof is a sole ulcer, this occurs when infection of the hoof is localised in an area of the hoof following injury, such as from stone damage, or more commonly from uneven weight distribution on the foot causing bruising; such an infection, if left untreated may result in a sole ulcer. To rectify this problem, it is beneficial to trim the hoof to remove the infected tissue, similar to wound debridement, by trimming the affected claw of the hoof to a non-infected region or at least a region of less infection should it not be prudent to trim further.

Following this trimming it is desirable to keep the trimmed claw above the level of the ground to prevent the cow from putting pressure on the affected or injured trimmed claw.

One method typically used to prevent the cow from putting pressure on the injured claw is to elevate the claws.

This is generally achieved by the attachment of material, typically a wooden block, to the other, healthy claw to elevate the affected claw. Such a block is known as a “hoof block” and is generally made from wood, rubber or a plastics material. The block is typically glued to the foot and the wood wears down over time or the adhesive strength of the glue weakens and the block falls off the claw. Occasionally, the block needs to be removed by the farmer, herdsman or hoof trimmer.

Another block attachment system is to attach the block with a resinous or putty-like material which encases the outer portion of the block and the hoof.

However, the problem encountered with the traditional application of the block is that the block may be prematurely or accidentally removed from the claw before the healing of the affected claw is complete.

More recently, a unitary device has been provided which works in manner similar to a shoe or even an orthopaedic “built up” shoe, the upper part of the shoe being intended to receive the trimmed claw and the sole portion which acts as the traditional block device for elevating the unaffected claw of the hoof.

Such unitary devices are generally formed from a plastics or other mouldable material as a single piece. The portion of the device which replicates the wooden block may be hollow, and is generally of an open-cell structure at least in cross section. An example of such a device is made and sold under the brand name of Demotec green shoe. Generally, such devices have been well received by farmers, herdsman and hoof trimmers due to their ease of fit. The device is adhered to the claw, for example with glue or putty, and so can be more quickly and easily fitted to the claw than by using a cohesive bandage.

However, it has been observed by the present inventors that in the unitary device the sole or block element does not always perform in the same manner as the traditional wooden block element applied to the claw. Disadvantages of the unitary device have been observed which include at a basic level the issue that such devices do not provide adequate traction in use and become slippery causing problems when the cow is walking on a hard surface. Of more concern however, is that the slower wear of the sole portion may actually lead to further injury or ulceration of the hoof. Additionally, after prolonged wear the new hoof growth can grow in a manner so as to surround the shoe, known as overgrowth.

Most of these problems could be simply overcome by making the unitary device from a different material.

The present inventors however, have devised an alternative system for attaching the wooden block to the claw, the system comprising a shaped upper shoe and a separate sole piece, the upper shoe being attachable to the claw and comprising means for retaining a sole piece inserted therein.

Accordingly, the present invention provides a hoof block retaining device for elevating a claw of a cloven hoof, particularly in a bovine animal, in which the device comprises means for receiving at least a portion of the claw to be inserted therein, a sole plate to sit below the claw and means for receiving and retaining a hoof block.

Preferably, the means for receiving and retaining the hoof block are provided in or on the sole plate of the device. Alternatively, the means for receiving and retaining the hoof block may be attachable to the sole plate.

The hoof block may be of conventional design or may be shaped to fit the retaining device.

It is preferred that the hoof block retaining device is shaped to fit a bovine claw. In a most preferred embodiment, the hoof receiving means of the retaining device is shaped to at least partially enclose a bovine claw such that at least the front portion of the hoof wall is enclosed by the device, but the rear of the hoof is not covered such that the flexor tendon of the animal is not stressed. It is preferred that the receiving means do not extend above the coronary band of the claw inserted therein.

The sole plate of the retaining device may support the claw. However, in some embodiments, only the outer edges adjacent the circumference of the sole horn may be supported by the sole plate. In such an embodiment the sole horn or underside of the claw may be supported by the upper surface of the hoof block.

The retaining device is preferably made from a plastics material. More preferably the retaining device is made from a biodegradable plastics or bioplastics material. The biodegradable plastics or bioplastics material may be an aliphatic polyesters, a polyhydroxyalkanoates (PHAs) such as poly-3-hydroxybutyrate (PHB), polyhydroxyvalerate (PHV) and polyhydroxyhexanoate (PHH), a polylactic acid (PLA), a polybutylene succinate (PBS), a polycaprolactone (PCL), a polyanhydride, polyvinyl alcohol, a cellulose derivative such as cellulose acetate or nitrocellulose, or another starch derivative. Alternatively a degradation enhancer may be added to the plastics material to facilitate degradation thereof. The degradation enhancer may be a metal salt, or a polylactic coglycolide (PLGA).

Optionally, the device may be flexible to prevent or reduce the likelihood of the device snapping during fitting. Hence, in one embodiment, the device may be made from an elastomeric material optionally comprising a degradation enhancer. An example of this is thermosetting polyurethane (TPU) with a degradation enhancer such as a polylactice coglycolide (PLGA) added thereto.

The retaining device may be made by moulding or printing. This facilitates the shaping of the device and especially the means for receiving and retaining the hoof block.

The means for receiving and retaining the hoof block may comprise a series of snap fit fasteners in one or both of the sole plate and the claw receiving means. Preferably however, the means for receiving and retaining the hoof block are integral with the sole plate. The means for receiving and retaining the hoof block may comprise a profiled lip which interacts with a reciprocal profile on or attached to the hoof block. For example, the means for receiving and retaining the hoof block may consist essentially of a substantially circumferential channel in the sole plate, defining a hole therein in which a hoof plate is insertable, the hoof plate has a reciprocal profile about its circumference which, in use, engages with the channel provided in the sole plate. The reciprocal profile may be discontinuous. Optionally, the hoof block may secured to the means for receiving and retaining the hoof block using an adhesive.

The term circumferential as used herein is not intended to restrict the hoof blocks to being circular but is intended to define that an element of the hoof block is lying around or just outside the edges or outskirts of the hoof block.

Alternatively, the hoof block may simply be force-fitted into the means for receiving and retaining the hoof block or held therein by friction.

In a preferred embodiment, the means for receiving and retaining the hoof block comprises a substantially circumferential flange about the sole plate of the retaining device. A hoof block is secured within the flange, optionally with the use of an adhesive.

In the most preferred embodiment, the retaining device is formed around the hoof block, for example by moulding or 3-D printing around a pre-formed hoof block.

The hoof block is preferably made from wood. The type of wood used can be varied to suit the environment of the animal that the block will be applied to. For example, conventional beech wood blocks may generally be used, but oak wood blocks may be used in areas where increased levels of abrasion may be encountered.

The present inventors have also found that tread pattern of the blocks can be varied to suit the environment of the animal and that using a raised tread pattern with conical, frustoconical, or truncated pyramid-like protrusions on the hoof block can be desirable to provide greater traction and so aid the stability of the animal.

The size of either the hoof block retaining device or the hoof block can be varied according to the size of the animal to which they are to be fitted.

Ideally, the hoof block is supplied already fitted into the hoof block retaining means forming a shoe.

The hoof block retaining device and/or the hoof block is preferably attached to the claw using an adhesive. In a preferred embodiment, the adhesive is particularly suited for use with animals.

In a final aspect of the invention, the present invention further provides an adhesive for attaching the hoof block retaining device of the present invention on a claw. Preferably, the adhesive is a polyurethane adhesive which cures around the claw, firmly adhering the claw to the inner surface of the hoof block retaining means and the upper side of the hoof block entrained therein. In the most preferred embodiment, the adhesive is a two-part polyurethane adhesive, which is mixed at the point of application, and which further comprises a thermochromatic indicator to provide a visual indication of the curing process, which in turn indicates the appropriate time to apply the retaining means or shoe to the claw. Bearing in mind that the curing of the adhesive is indicated by a colour change or a colour loss, a suitable adhesive component will not be one that would disguise the intended colour change.

It is preferred that the thermochromatic indicator is present in the resin part of the two-part system before mixing of the parts. The thermochromatic indicator imparts a colour, prior to mixing, to the part in which it is present. It is preferred that the indicator loses colour during the curing process so that curing is indicated by a loss of colour; decolouring of the indicator in the mixture preferably begins as soon as the component parts are mixed together and is complete, at the latest on curing of the mixture.

In the most preferred embodiment, the two-part polyurethane adhesive comprises a diethylmethylbenzenediamine resin part and a diphenylmethane diisocyanate (or its isomers or homologues) hardener.

The thermochromatic indicator may be any conventional thermochromatic indicator and may be selected from phthaleins, eosin, fluorescein, rhodamine, phenolphthalein, 3-diethylamino-6-methyl-7-chloro-fluoran, 3,6 dimethoxyfluoran, 3-cyclohexyl-6-chloro-fluoran, crystal violet lactone, 3-diethyamino-6-methyl-7-anilino-fluoran, phenosafranin (3,7-diamino-5-phenylphenazinium chloride), methyl derivatives of azobenzene 4-azo-2naphthol, Reaktred 448 (diazo rhodamine lactone) [BASF], azarhodamine lactones and 1,2-benzo-6-diethylamine-fluoran.

In the ideal embodiment on mixing the components the thermochromatic indicator indicates mixing by turning pink and fades or loses colour to cream when curing occurs.

Embodiments of the invention will now be described, with reference to and as illustrated by FIGS. 1 to 4 of the accompanying drawings of which

FIG. 1 shows a perspective view of one embodiment of the hoof block retaining device of the present invention,

FIG. 2 shows a detail of the means for receiving and retaining the hoof block taken along arrow X-X of FIG. 1,

FIG. 3 shows a detail of an alternative means for receiving and retaining the hoof block,

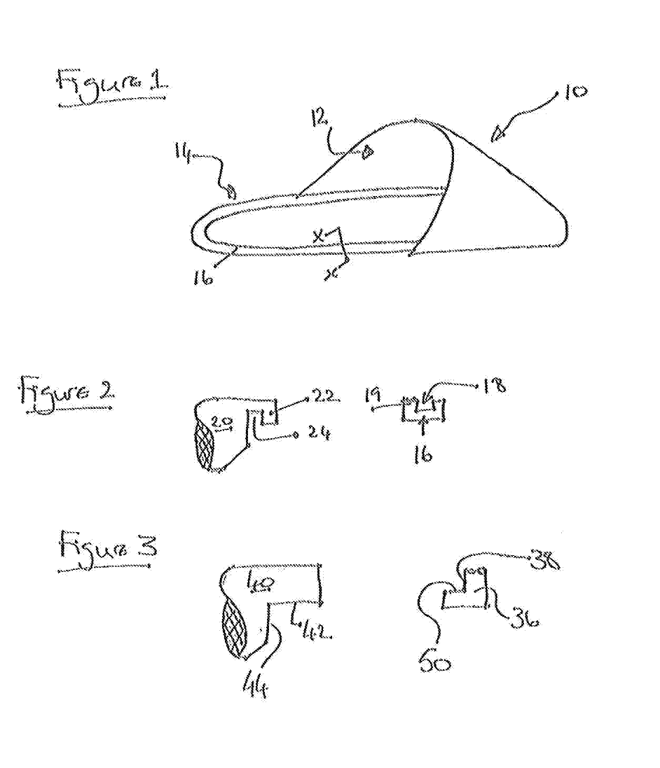

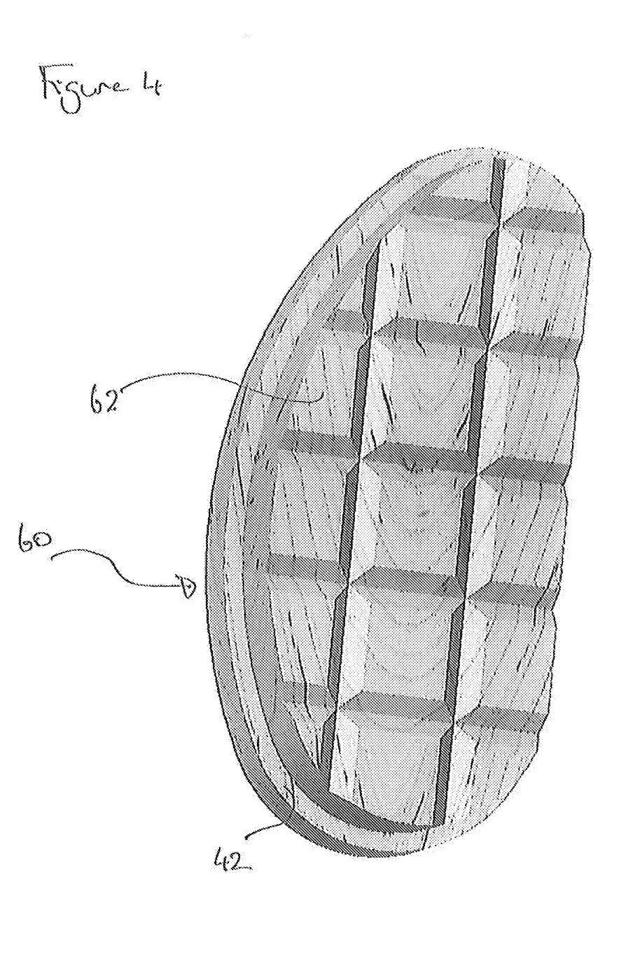

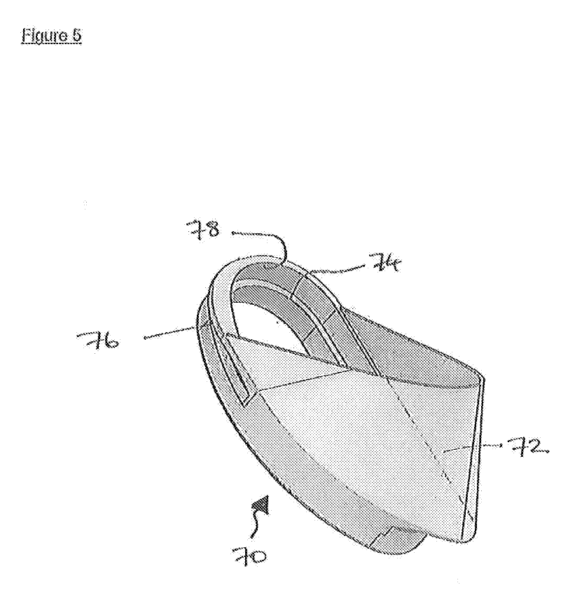

FIG. 4 shows a hoof block usable with the means for receiving and retaining the hoof block of FIG. 3,

FIG. 5 shows the preferred embodiment of the hoof block retaining device of the present invention, and

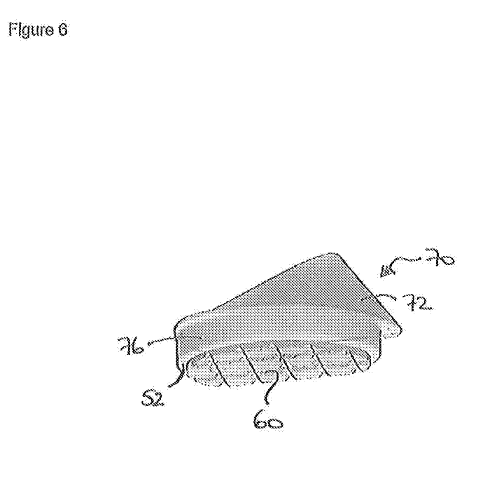

FIG. 6 shows the hoof block retaining device of FIG. 5 with a hoof block inserted therein.

### EXAMPLES

In a first embodiment, the hoof block retaining device 10 comprises means 12 for receiving at least a portion of the claw to be inserted therein, a sole plate 14 to sit below the claw and means 16 for receiving and retaining a hoof block. The receiving means 12 of the device 10 is shaped to accommodate either the lateral or the medial claw of a bovine animal such as a cow. In this embodiment the sole plate 14 is comprised of a narrow band defining the perimeter of circumference of the device 10 and wholly contains the means 16 for receiving and retaining the hoof block 20 (partial view in FIG. 2).

The receiving and retaining means 16 defines a channel 18 for receiving a profiled element in the form of a lip 22 of hoof block 20. For added security, to prevent lateral slippage, in use groove 24 of block 20 houses an arm 19, which is one of the arms defining channel 18, of the receiving and retaining means 16. In this embodiment, prior to application to a cow, block 20 is inserted into the device 10 such that the lip 22 engages with the channel 18 and the groove 24 houses arm 19 to secure the block 20 in the device 10. The device 10 is then fitted to the claw of a cow to balance the hoof and is secured in place, for example by use of an adhesive.

In a second embodiment, shown in FIG. 3, the shape and positioning of the claw receiving means is the same as in the first embodiment but the receiving and retaining means are of a simple construction. The means for receiving and retaining the hoof block 40 comprises a circumferential flange 50. The hoof block 40 comprises a circumferential lip 42 whereby, in use, lip 42 rests on flange 50 and is prevented from lateral slippage by the wall 38 of sole plate 36 and the wall 44 of the hoof block 40.

With reference to FIG. 4, a hoof block 60 of the invention is shown. The hoof block 60 has a tread pattern of truncated pyramids 62 arranged in a grid pattern. It has been found that such a tread pattern improves the traction of the hoof block and improves the gait of the cow wearing the hoof block which in turn prevents lameness of the cow. The block 60 has the same circumferential lip 42 as in FIG. 2 to engage with a flange 50 in the retaining device of the invention.

In the preferred embodiment, shown in FIGS. 5 and 6, the hoof block retaining device 70 comprises means 72 for receiving at least a portion of the claw to be inserted therein the shape and positioning of the claw receiving means is similar to that shown in FIG. 3. The means 72 for receiving and retaining the hoof block comprises a circumferential flange 74. The hoof block 60 comprises a circumferential lip 42 whereby, in use, lip 42 rests on flange 72 and is prevented from lateral slippage by the wall 78 of sole plate 76 and the wall 44 of the hoof block 60.

In use, the hoof block 20, 40, 60 is inserted into the hoof block retaining device 10, 60, 70 to form a shoe and applied to the claw of an animal being treated, optionally using an adhesive. Where the adhesive of the invention is used, the user heats the two component parts of the adhesive before mixing, the mixed polyurethane resin is applied to the inside of the shoe made up of the hoof block retaining means and the hoof block fitted therein, the mixture will lose colour from pink to cream as the adhesive cures, when the mixture turns cream the user applies the shoe to the claw and pushes the shoe firmly against the claw. When the shoe can be tugged by the user, with little to no movement the user can move onto another claw or animal.

1. A hoof block retaining device for elevating one claw of a cloven hoofed animal, in which the device comprises means for receiving at least a portion of the claw to be inserted therein, a sole plate to sit below the claw in use and means for receiving and retaining a hoof block.

2. A device according to claim 1, in which the means for receiving and retaining the hoof block are provided in or on the sole plate of the device.

3. A device according to claim 1, in which the means for receiving and retaining the hoof block may be attachable to the sole plate.

4. A device according to any one of claims 1 to 3 in which device is shaped to fit the claw to which it is to be attached.

5. A device according to claim 4, in which the hoof receiving means of the retaining device is shaped to partially enclose the claw such that at least the front portion of the hoof wall is enclosed by the device, but the rear of the hoof is not covered such that the flexor tendon of the animal is not stressed.

6. A device according to claim 4 or claim 5, in which, in use, the claw receiving means do not extend above the coronary band of the claw inserted therein.

7. A device according to any one of the preceding claims, in which the device is made from a plastics material.

8. A device according to claim 7, in which the device is made from a biodegradable plastics or bioplastics material.

9. A device according to claim 8 in which the biodegradable plastics or bioplastics material is an aliphatic polyester, a polyhydroxyalkanoate (PHAs) such as poly-3-hydroxybutyrate (PHB), polyhydroxyvalerate (PHV) and polyhydroxyhexanoate (PHH), a polylactic acid (PLA), a polybutylene succinate (PBS), a polycaprolactone (PCL), a polyanhydride, polyvinyl alcohol, a cellulose derivative such as cellulose acetate or nitrocellulose, or another starch derivative.

10. A device according to any one of claims 1 to 7 in which a degradation enhancer is be added to the plastics material to facilitate degradation thereof.

11. A device according to any one of claims 1 to 6 in the device is at least partially flexible to prevent or reduce the likelihood of the device snapping during fitting.

12. A device according to claim 11 in which the device is made from an elastomeric material optionally comprising a degradation enhancer.

13. A device according to any one of the preceding claims, in which the device is made by moulding or printing.

14. A device according to any one of the preceding claims, in which the means for receiving and retaining the hoof block are integral with the sole plate.

15. A device according to claim 14, in which the means for receiving and retaining the hoof block comprise a profiled lip which interacts with a reciprocal profile on or attached to the hoof block.

16. A device according to claim 15 in which the reciprocal profile is discontinuous.

17. A device according to any one of the preceding claims, in which the hoof block is force-fitted into the means for receiving and retaining the hoof block or held therein by friction.

18. A device according to any one of claims 1 to 14 in which the means for receiving and retaining the hoof block comprises a substantially circumferential flange about the sole plate of the retaining device.

19. A device according to any one of claim 1 to 16 or 18 in which the hoof block is secured to the means for receiving and retaining the hoof block using an adhesive.

20. A device according to any one of claims 1 to 14 in which the means for receiving and retaining the hoof block comprises a series of snap fit fasteners in one or both of the sole plate and the claw receiving means.

21. A device according to any one of the preceding claims, in which the retaining device is formed around the hoof block.

22. A device according to any one of the preceding claims, in which the hoof block is made from wood.

23. A device according to claim 22 in which the hoof block is made from beech or oak.

24. A hoof block shaped to fit the retaining device of claims 1 to 23.

25. A hoof block according to any one of claims 22 to 24 having a raised tread pattern with conical, frustoconical, or truncated pyramid-like protrusions.

26. A hoof block retaining device or a hoof block as described in any one of the preceding claims, in which the animal with a cloven hoof is a bovine animal.

27. A hoof block retaining device or a hoof block as described in any one of the preceding claims, in which the animal with a cloven hoof is a cow or a bull.

28. A hoof block retaining device or a hoof block as described in any one of claims 1 to 25, in which the animal is an ovine or caprine animal.
